(19) United States
(12) Patent Application Publication
(10) Pub. No.: US 2022/0363120 A1
(43) Pub. Date: Nov. 17, 2022

(54) Method and Electric Engine Block for Converting a Vehicle With an Internal Combustion Engine Into an Electric Vehicle

(71) Applicant: Schuyler Walker, Winnetka, IL (US)

(72) Inventor: Schuyler Walker, Winnetka, IL (US)

(21) Appl. No.: 17/741,163

(22) Filed: May 10, 2022

Related U.S. Application Data
(60) Provisional application No. 63/187,183, filed on May 11, 2021.

(51) Int. Cl. B60K 1/04; B62D 65/02

(52) U.S. Cl. CPC B60K 1/04; B62D 65/024; B60K 2001/001

(57) ABSTRACT

A method of converting a vehicle into an electric vehicle that includes detaching an internal combustion engine block from a frame of a vehicle to which a first wheel and a second wheel are attached and, after detaching the internal combustion engine block, attaching an electric engine block to the frame.

The present application claims priority under 35 U.S.C. § 119(e) of U.S. Provisional Patent Application Ser. No. 63/187,183, filed on May 11, 2021, the entire contents of which is incorporated herein by reference.

### BACKGROUND OF THE INVENTION

### Field of the Invention

The present invention is directed to a method and an electric engine block for converting a vehicle with an internal combustion engine into an electric vehicle, such as an electric engine automobile.

### Background Art

It is known that traditional vehicles, such as cars, trucks and other methods of transportation, that were fueled by fossil fuels, such as gasoline or diesel fuel, included internal combustion engine blocks that housed components of the internal combustion engine, such as pistons and cylinders. An example of an internal combustion engine block is disclosed in U.S. Pat. No. 10,934,969, the entire contents of which are incorporated herein by reference.

Internal combustion engine blocks are usually made of cast iron and are known to be heavy, ranging from 160 to 620 pounds in weight. The magnitude of the weight of an internal combustion engine block leads to a decrease in the efficiency of the vehicle.

As is well known, internal combustion engine blocks that run on fossil fuels will generate emissions that are harmful to the environment. In response to the environmental harm caused by vehicles powered by internal combustion engine blocks that run on fossil fuels, electric vehicles powered by electric engine blocks have been developed. An example of an electric vehicle is disclosed in U.S. Pat. No. 11,247,573 and corresponding U.S. Patent Application Publication No. 2020/0207220, the entire contents of each of which are incorporated herein by reference.

Economic and governmental pressures are pressuring customers to buy electric vehicles over internal combustion engine vehicles. In the case of economic pressures, rising gasoline and diesel fuel prices may become significant enough that the day-to-day costs of using an electric vehicle will be lower than the day-to-day cost of using an internal combustion engine vehicle. One barrier for a user to switch from an internal combustion engine vehicle to an electric vehicle is that it might not fit the budget of a user that recently bought an internal combustion vehicle at say a cost ranging from $25,000 to $30,000 and is faced with spending an additional $25,000 to $30,000 for an electric vehicle.

It is an object of the present invention to convert a vehicle with an internal combustion engine to a vehicle with an electric engine block and thus leading to a more efficient and environmentally friendly engine and vehicle.

It is an object of the present invention to provide an electric engine block that allows a user to convert a vehicle using an internal combustion engine block to an electric vehicle so that the user makes a significant savings in costs.

### SUMMARY OF THE INVENTION

One aspect of the present invention regards a method of converting a vehicle into an electric vehicle that includes detaching an internal combustion engine block from a frame of a vehicle to which a first wheel and a second wheel are attached and, after detaching the internal combustion engine block, attaching an electric engine block to the frame.

A second aspect of the present invention regards an electric engine block that includes a power generation portion and a base that has a pattern of openings that are spaced so as to be aligned with a plurality of openings of a frame of a vehicle that are used for attachment of an internal combustion engine block with the frame.

One or more aspects of the present invention provide the advantage of converting a vehicle into a more efficient and environmentally friendly engine and vehicle.

One or more aspects of the present invention provide the advantage of allowing a user to convert a vehicle using an internal combustion engine block to an electric vehicle so that the user makes a significant savings in costs.

### BRIEF DESCRIPTION OF THE DRAWINGS

The various features, advantages and other uses of the present apparatus will become more apparent by referring to the following detailed description and drawing in which:

FIG. 1 schematically shows a perspective and partial internal view of an embodiment of a known vehicle that employs an internal combustion engine block;

FIG. 2 schematically shows an embodiment of a frame that can be used with the vehicle of FIG. 1;

FIG. 3 shows an embodiment of an oil pan that can support an internal combustion engine block on the frame of FIG. 2;

FIG. 4 shows an embodiment of an internal combustion engine block supported on and attached to the frame of FIG. 2;

FIGS. 5 and 6 show schematic and perspective views of another embodiment of an internal combustion engine block being coupled to the frame of FIG. 2;

FIGS. 7 and 8 show schematic and perspective views of another embodiment of an internal combustion engine block being coupled to the frame of FIG. 2;

FIG. 9 schematically shows a perspective view of a mode of converting the vehicles of FIGS. 1-8 into a vehicle with an electric engine block;

FIG. 10 schematically shows a top view of the electric engine block of FIG. 9;

FIG. 11 shows a stage of the mode of converting of FIG. 9, wherein an electric engine block is attached to the frame of FIG. 2 and provides for front wheel drive of the vehicle; and

FIGS. 12 and 13 show schematic and perspective views of another embodiment of an internal combustion engine block being coupled to the frame of FIG. 2.

### DETAILED DESCRIPTION

As shown in the exemplary drawing figures is an embodiment of a vehicle, wherein an electric engine block is used in lieu of a traditional internal combustion engine block, wherein like elements are denoted by like numerals.

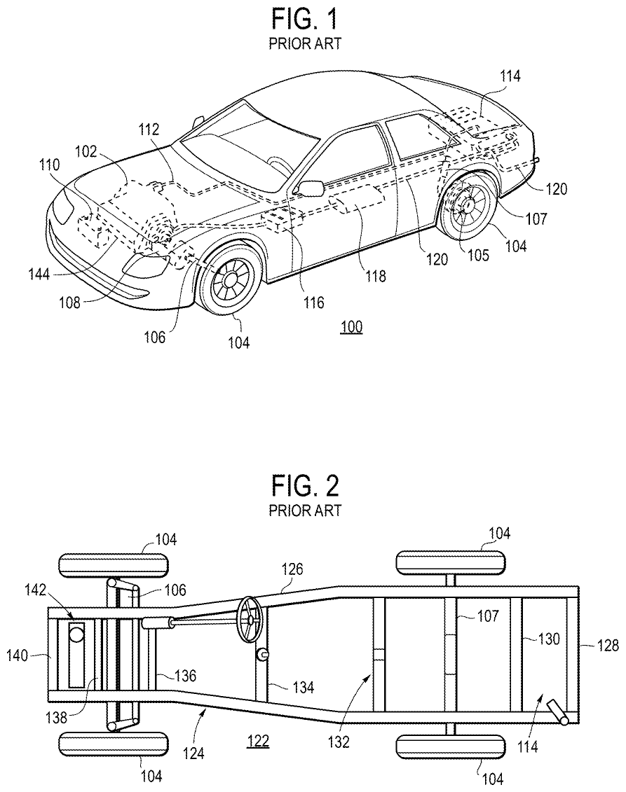

FIG. 1 schematically shows an embodiment of a known vehicle 100 that uses an internal combustion engine block 102. The vehicle 100 includes multiple wheels, such as four wheels 104 (two wheels not shown). A brake 105 and a shock absorber 107 are associated with each wheel 104 in a well-known manner. Pairs of left and right wheels 104 are coupled to each other by axles (not shown) in a well-known manner. In the case of a front-wheel vehicle 100, the front axle 106 of the front wheels 104 is coupled to a transmission 108, which in turn is coupled to the internal combustion engine block 102. If a rear-drive vehicle is at issue, then a transmission can be oriented to couple with a propeller shaft that drives the rear axle 107 (See FIG. 2) in a well-known manner. A battery 110 is in electrical communication with the internal combustion engine block 102 in a well-known manner.

As shown in FIG. 1, the vehicle 100 requires a fuel line 112 so that fuel, such as gasoline or diesel fuel, is led from a fuel tank 114 to the internal combustion engine block 102 in a well-known manner. The vehicle 100 also requires structure for dispensing exhaust and reducing noise generated from the internal combustion engine 102. Such structure is well-known in the form of a catalytic converter 116, a muffler 118, and an exhaust pipe 120.

In order to support various components of the vehicle 100, such as the internal combustion engine block 102, a frame 122 is constructed. The frame 122 is made of a durable material, such as steel. As shown in FIG. 2, the frame 122 includes a left side member 124 and a right side member 126 that are positioned generally parallel to one another. Connection between the left side member 124 and the right side member 126 is achieved by a plurality of horizontal members 128, 130, 132, 134, 136, 138, and 140. Such connection can be achieved by the use of nuts and bolts or welds. As shown in FIG. 2, other components of the vehicle 100 that can be supported by the frame 122 are the fuel tank 114 and a radiator 142.

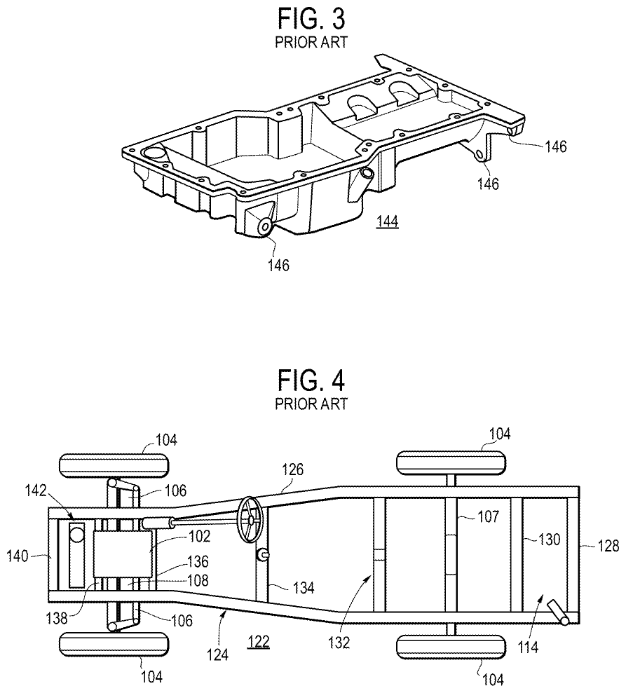

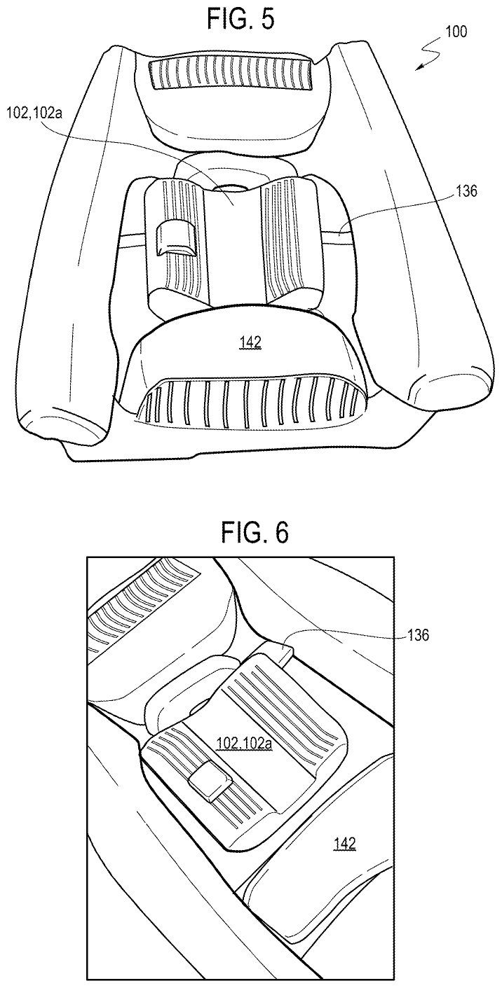

As shown in FIG. 2, the internal combustion engine block 102 has not yet been attached to the frame 122. Attachment is achieved via the oil pan 144 that is located at the underside of the internal combustion engine block 102. As shown in FIG. 3, the oil pan 144 has openings 146 that align with corresponding openings formed in the left side member 124, right side member 126, horizontal member 136, and/or horizontal member 138. Bolts are inserted into the aligned openings so as to attach the oil pan 144 and the remainder of the internal combustion engine block 102 to the frame 122. Once the openings of the internal combustion engine block 102 are aligned with the openings of the frame 122, bolts are inserted into the aligned openings and secured to the internal combustion engine block 102 and frame 122 via nuts. FIGS. 5 and 6 schematically show the situation where an internal combustion engine block 102 is attached to the frame 122 via horizontal member 136 and is oriented so as to provide for rear wheel drive.

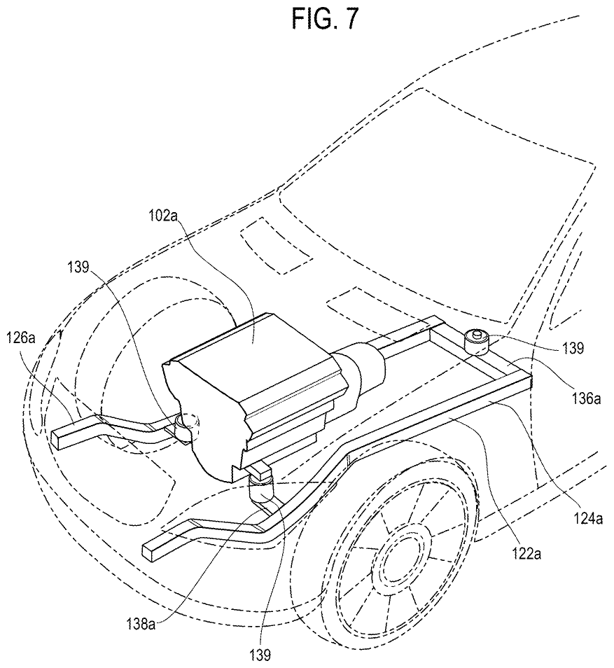

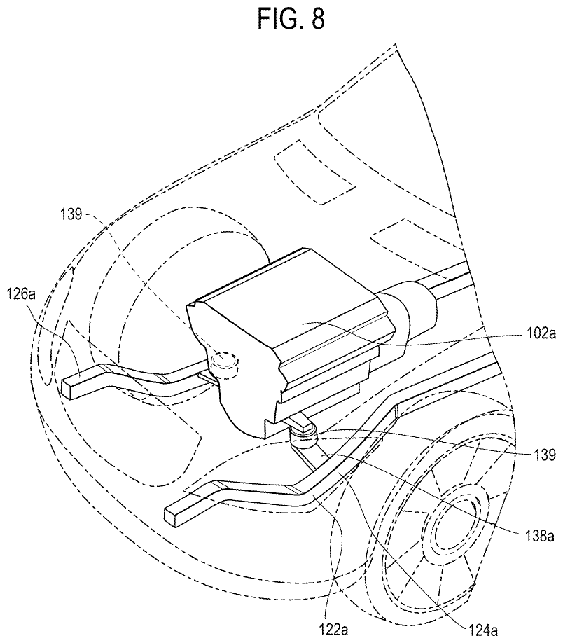

FIGS. 7 and 8 schematically show another situation where an internal combustion engine block 102a is attached to the frame 122a via horizontal member 136. The frame 122a has a left side member 124a and a right side member 126a that are positioned generally parallel to one another. Connection between the left side member 124a and the right side member 126a is achieved by horizontal members 136a and 138a, which can be attached to the left and right side members 124a and 126a via nuts and bolts or welds. As shown in FIGS. 7 and 8, the horizontal member 138a includes reinforced mounting members 139 that include mounting openings that are aligned with openings of the internal combustion engine block 102a. As shown in FIG. 7, the horizontal member 136a includes a reinforced mounting member 139 that has a mounting opening aligned with an opening of the internal combustion engine block 102a. Once the openings of the reinforced mounting members 139 described previously are aligned with openings of the internal combustion engine block 102a, bolts are inserted into the openings and secured to the internal combustion engine block 102a and frame 122a via nuts. As shown in FIG. 2, other components of the vehicle 100 that can be supported by the frame 122a are the fuel tank 114 and a radiator 142.

It should be kept in mind that other frames and attachments between the frames and the internal combustion engine blocks mentioned previously are possible. In addition, while the examples given in FIGS. 1-8 regard automobiles, the present invention can be equally applied to other vehicles, such as motorcycles and boats, that have an internal combustion engine block attached to a frame.

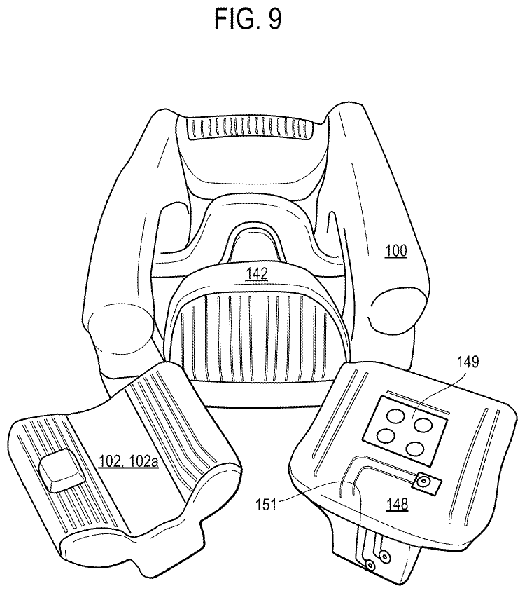

Conversion of the vehicle 100 into a vehicle that has an electric engine block is accomplished by detaching the bolts that attach the internal combustion engine blocks 102, 102a to their respective frames 122, 122a. Next, the internal combustion engine blocks 102, 102a are removed from the interior of the vehicle 100 and placed to the side as schematically shown in FIG. 9. Other components of the vehicle 100 are removed, which are no longer necessary with the removal of internal combustion engine blocks 102, 102a. For example, the fuel line 112, fuel tank 114, the catalytic converter 116, the muffler 118, and the exhaust pipe 120 are removed.

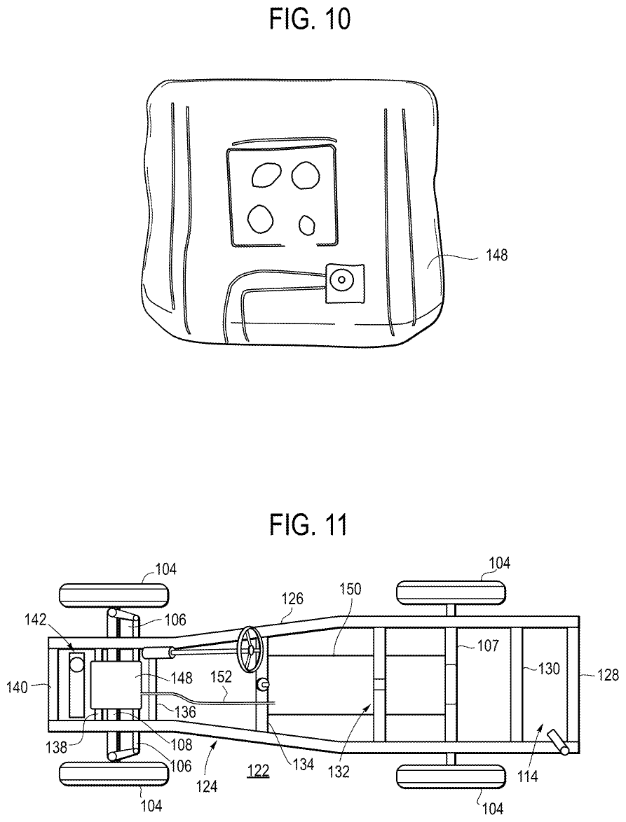

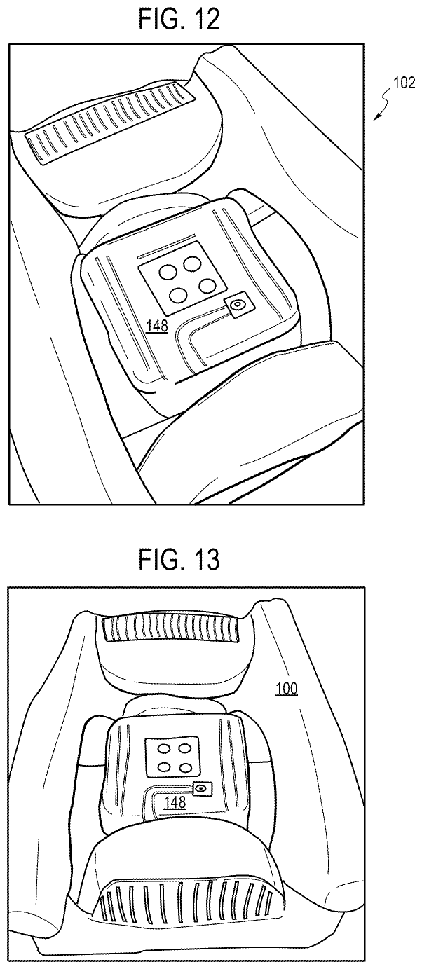

Next, an electric engine block 148 (schematically shown in FIGS. 9 and 10) is inserted into the cavity of the vehicle 100 that previously housed the internal combustion engine blocks 102, 102a. The electric engine block 148 includes a power generation portion 149 that and a base 151 that align with the openings of the frames 122, 122a that were aligned with the openings of the corresponding internal combustion engine blocks 102, 102a during attachment as described previously. Once the openings of the electric engine block 148 are aligned with the openings of the frames 122, 122a, bolts are inserted into the aligned openings and secured to the electric engine block 148 and frames 122, 122a via nuts.

It is envisioned that the electric engine block 148 has multiple patterns of openings, wherein one pattern of openings align with openings of the frame 122 of one type of vehicle, a second pattern of openings align with openings of the frame 122a of a second type of vehicle, a third pattern of openings align with openings of a third frame of a third type of vehicle, and so on. Thus, when the internal combustion engine block of a particular type of vehicle is removed, the corresponding pattern of openings of the electric engine block 148 are aligned with the openings of the frame and bolts and nuts are used for attaching the electric engine block 148 to the frame in the manner described previously. Thus, electric engine block 148 can be used to replace internal combustion engine blocks for multiple types of different vehicles.

As shown in FIG. 11, a battery pack 150, such as those sold by BYD or LG Chem, is attached to the frame 122 directly or indirectly. In the case of direct attachment, the battery 150 has openings that align with the openings of the frame 122. Once the openings of the battery 150 are aligned with the openings of the frame 122, bolts are inserted into the aligned openings and secured to the battery 150 and frame 122 via nuts. Indirect attachment is accomplished by having the battery 150 secured to the top surface of a support plate, wherein a bottom surface of the support plate is welded to or bolted to the frame 122. Cabling 152 connects the battery 150 and the electric engine block 148, wherein an inverter (not shown) receives direct current from the batter 150 and sends alternating current to the electric engine block 148 in a well-known manner. The electric engine block 148 can include computer chips and wires so that the electric engine block can send and receive signals that control its operation. The electric engine block 148 is made of a material lighter than the cast iron of known internal combustion engines, such as a carbon fiber material. Besides being attached to the battery 150, the electric engine block 148 is attached to the transmission 108 for front-wheel drive, wherein a rotor (not shown) of the electric engine block 148 engages the transmission (not shown) of the vehicle 100 that originally engaged the internal combustion engine block 102 102a. Of course, the electric engine block 148 and transmission 108 can be adapted to provide rear-wheel drive in a manner similar to that described previously.

With the electric engine block 148 and battery 150 in place, various wiring and cabling are connected with the battery so as to power the remaining electrical components of vehicle 100.

Operation of the electric vehicle 100 is similar to an internal combustion vehicle in that a driver enters the electric vehicle 100 via a door and sits on a seat (not shown) that is positioned behind a steering wheel (not shown). The driver starts up the electric engine block 148 by pressing an ignition button or using an ignition key in a well-known manner. Starting up the electric engine block 148 allows for direct electric current from the battery 150 to flow into an inverter (not shown) which generates alternating electric current to power the electric engine block 148. The alternating electric current received by the electric engine block 148 causes the rotor of the electric engine block 148 to rotate and engage the transmission (not shown) which leads to the rotation of the axles and, thus, rotation of the wheels associated with the rotating axles.

While the above description of the conversion of the vehicle 100 regards an automobile, the present invention can be applied to other types of vehicles 100 that have an internal combustion engine, such as trucks, buses, construction vehicles, motorcycles, boats, and airplanes.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

I claim:

1. A method of converting a vehicle into an electric vehicle, the method comprising:
detaching an internal combustion engine block from a frame of a vehicle to which a first wheel and a second wheel are attached; and
after detaching the internal combustion engine block, attaching an electric engine block to the frame.

2. The method of claim 1, wherein a third wheel and a fourth wheel are attached to the frame from which the internal combustion engine block is detached.

3. The method of claim 1, wherein the first wheel and the second wheel are attached to one another via an axle.

4. The method of claim 1, wherein the internal combustion engine block is coupled to a transmission which rotates the axle prior to detaching the internal combustion engine from the frame and the electric engine block is coupled to the transmission so as to rotate the axle.

5. The method of claim 4, wherein the transmission is coupled to a propeller shaft that rotates the axle.

6. The method of claim 1, wherein the vehicle comprises a liquid fuel tank, wherein the method further comprises removing the liquid fuel tank from the vehicle so that the vehicle does not have the liquid fuel tank while the electric engine block is attached to the frame.

7. The method of claim 1, wherein the frame comprises:
a first side member and a second side member that are positioned generally parallel to one another;
a first horizontal member connected to the first side member and the second side member; and
a second horizontal member connected to the first side member and the second side member and positioned generally parallel to the first horizontal member;
wherein the first horizontal member has an opening into which a bolt is inserted and connects the internal combustion engine block to the frame;
wherein detaching the internal combustion engine block comprises removing the bolt from the opening; and
wherein attaching the electric engine block comprises attachment via the opening.

8. The method of claim 7, wherein the attaching the electric engine block comprises aligning an opening of the electric engine block with the opening of the block and insertion of a bolt through the aligned opening of the electric engine block and the aligned opening of the frame.

9. The method of claim 1, further comprising attaching a battery to the frame, wherein the battery is in electrical communication with the electric engine block.

10. The method of claim 1, wherein the vehicle is an automobile.

11. An electric engine block comprising:
a power generation portion; and
a base that has a pattern of openings that are spaced so as to be aligned with a plurality of openings of a frame of a vehicle that are used for attachment of an internal combustion engine block with the frame.

12. The electric engine block of claim 11, wherein the base has a second pattern of openings that are spaced so as to be aligned with a second plurality of openings of a second frame of a second vehicle that are used for attachment of a second internal combustion engine block with the second frame.
